(19) United States
(12) Patent Application Publication
(10) Pub. No.: US 2012/0019354 A1
(43) Pub. Date: Jan. 26, 2012

(54) Methods and Devices for a Multi-Protocol Wireless Security Controller

(75) Inventors: Paul Glendenning Saldin, Stillwater, MN (US); John Todd Bergman, River Falls, WI (US)

(73) Assignee: Quel Technologies, Inc., Roseville, MN (US)

(21) Appl. No.: 13/148,135

(22) PCT Filed: Jan. 15, 2010
(86) PCT No.: PCT/US10/21198

§ 371 Date: Aug. 5, 2011

Related U.S. Application Data
(60) Provisional application No. 61/150,527, filed on Feb. 6, 2009.

(51) Int. Cl. G06F 7/00

(52) U.S. Cl. 340/5.1

(57) ABSTRACT

Methods and devices for a wireless security controller that is able to receive data transmissions over multiple frequency channels and decode security messages that use different data protocols is provided. The security controller monitors an incoming security message transmission from a security sensor. As the transmission is received, the security controller analyzes the data, and determines whether is encoded using one of two or more different transmission protocols. The security controller then completes reception and error-checking of the received security message, and processes the security message.

### PRIORITY INFORMATION

This application is being filed as a PCT International Stage Application in the name of SEQUEL TECHNOLOGIES, INC. and claims the benefit of priority of U.S. Provisional Patent Application No. 61/150,527 filed 6 Feb. 2009 and entitled “METHODS AND DEVICES FOR A MULTI-PROTOCOL WIRELESS SECURITY CONTROLLER” which is hereby incorporated by reference in its entirety.

### FIELD

This disclosure relates generally to the field of security systems. More particularly, the disclosure relates to methods and devices for a multi-protocol wireless security controller.

### BACKGROUND

Wireless communication between one or more security sensors and a wireless security controller in a security system is known. However, manufacturers of security equipment have each implemented their own unique and independent protocols and use their own frequency channels to transmit sensor information from security sensors to a security controller. Security system installation dealers that choose to use equipment from more than one manufacturer must maintain duplicate inventory for security sensors that are functionally identical except for the protocol the sensors use to communicate to the security controller.

### SUMMARY

This disclosure relates to methods and devices for a wireless security controller that is able to receive data transmissions over multiple frequency channels and decode security messages that use different data protocols.

Methods and devices for a wireless security controller that is able to receive data transmissions over multiple frequency channels and decode security messages that use different data protocols is provided. The security controller monitors an incoming security message transmission from a security sensor. As the transmission is received, the security controller analyzes the data, and determines whether the data is encoded using one of two or more different transmission protocols. The security controller then completes reception and error-checking of the received security message, and processes the security message.

In one embodiment, the security controller operates in either a first mode or a second mode. The first mode allows the security controller to differentiate between security messages that use a security controller's manufacturer transmission protocol (also referred herein as the third transmission protocol) and security messages that use a first transmission protocol of a first manufacturer to allow the security message to be properly decoded. The second mode allows the security controller to differentiate between security messages that use the third transmission protocol and security messages that use a second transmission protocol of a second manufacturer to allow the security message to be properly decoded. As different manufacturers use different frequency channels for communicating security messages, the first mode is set to receive security messages that use the first transmission protocol over a first frequency channel. Similarly, the second mode is set to receive security messages that use the second transmission protocol over a second frequency channel. The security controller is able to receive security messages sent from security sensors that use the third transmission protocol over both the first frequency channel and the second frequency channel. Further, for each of the first transmission protocol, the second transmission protocol and the third transmission protocol, a preamble consisting of repeating data bits are used to provide a time during which a data clock can be developed to decode the actual message bits of the security message.

In one embodiment, the security controller uses the frequency channel on which the security message was received, the polarity of the start bit of the security message and the checksum verification to differentiate between different transmission protocols. In other embodiments, the security controller may only require the frequency channel that the security message was received and the polarity of the start bit of the security message or may only require the polarity of the start bit of the security message and the checksum verification to differentiate between different transmission protocols.

Other factors that may be used to differentiate transmission protocols used in a security message may include, but are not limited to; the length of the security message; the data rate of the security message; the preamble length of the security message; the message length of the security message; the message checksum of the security message; the fixed data bits within messages of the security message; the modulation type of the security message (e.g., Amplitude Shift Key “ASK”, Frequency Shift Key “FSK”, On/Off Key “OOK”, etc.); etc.

In one embodiment, the security controller can be modified after manufacturing to receive and decode security messages using additional types of transmission protocols and to differentiate between four or more different transmission protocols.

Advantageously, these embodiments provide a retrofit security controller that is capable of decoding security messages transmitted from security sensors that are encoded using different transmission protocols and transmitted over different frequency channels. Accordingly, a security system installation dealer can mix and match security sensors from different manufacturers, such as General Electric, Inc., Honeywell, Inc. and Sequel Technologies, Inc. that have unique and independent transmission protocols and transmit information at different frequency channels and remain compatible with a single security controller, thereby reducing costs and decreasing the amount of inventory space needed to store security system equipment.

### DESCRIPTION OF THE DRAWINGS

FIG. 1 is a block diagram of a wireless security system according to one embodiment.

FIG. 2 is a block diagram of a security controller according to one embodiment.

FIG. 3 is a block diagram of a transceiver module for use in a security controller of a wireless security system according to one embodiment.

FIG. 4 is a simplified high-level flow chart of a method for receiving a communication message over multiple protocols according to one embodiment.

FIG. 5 are digital timing diagrams of two portions of two security messages using Manchester encoding.

FIG. 6 is a digital timing diagram of portions of a security message using a pulse width based encoding.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice what is claimed, and it is to be understood that other embodiments may be utilized and that logical, mechanical and electrical changes may be made without departing from the spirit and scope of the claims. The following detailed description is, therefore, not to be taken in a limiting sense.

Embodiments presented herein involve methods and devices for a multi-protocol wireless security controller. Advantageously, these embodiments provide a retrofit security controller that is capable of decoding security messages transmitted from security sensors that are encoded using different transmission protocols and transmitted over different frequency channels. Accordingly, a security system installation dealer can mix and match security sensors from different manufacturers, such as General Electric, Inc., Honeywell, Inc. and Sequel Technologies, Inc. that have unique and independent transmission protocols and transmit information at different frequency channels and remain compatible with a single security controller, thereby reducing costs and decreasing the amount of inventory space needed to store security system equipment.

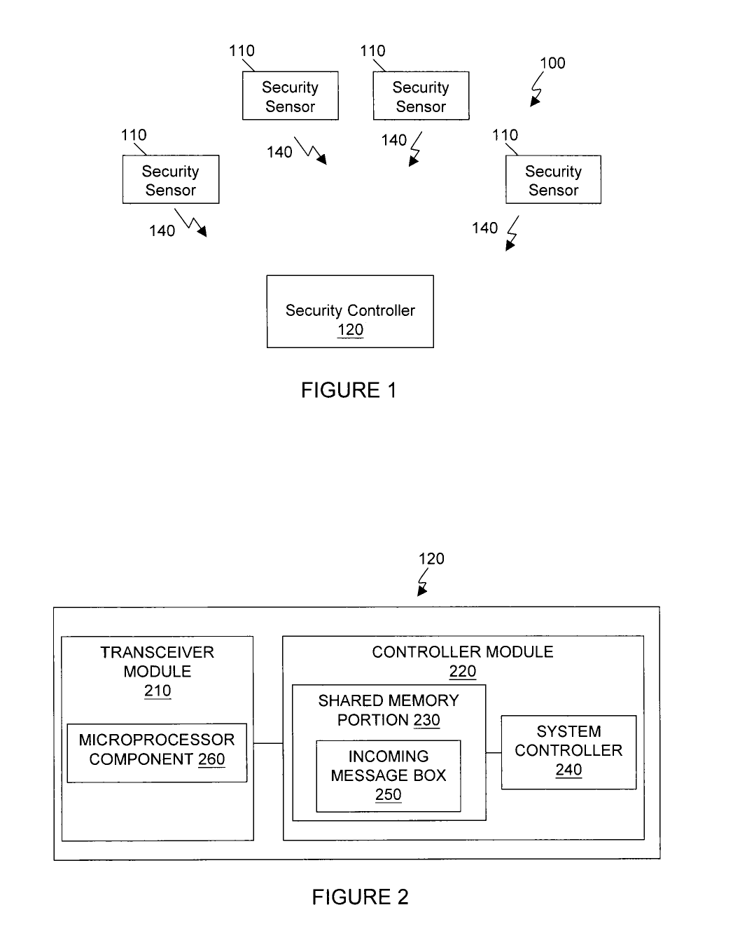

FIG. 1 is a block diagram of a wireless security system 100 according to one embodiment of the present invention. The wireless security system 100 can be similar to the wireless security system described in U.S. patent application Ser. No. 11/945,607, entitled “SYSTEMS AND METHODS FOR PROVIDING FREQUENCY DIVERSITY IN SECURITY TRANSMITTERS”, herewith incorporated by reference in its entirety. The wireless security system 100 comprises one or more wireless security sensor devices 110 used for monitoring an area and a security controller 120. Each wireless security sensor device 110 can include one or more of the following exemplary devices: a door/window sensor that detects when a portal is opened; a motion detector that detects movement within a space; a smoke detector that detects smoke within an area; a heat detector that detects excessive heat within an area; a low temperature detector that detects a potentially hazardous temperature within an area; a glass-break detector which detects a breakage of glass. The security sensor device 110 can also be a device initiated by a user, for example a key fob that allows the user to initiate a communication message by pressing a button on the key fob. However, it would be obvious for one skilled in the art to include other types of security sensors that detect, sense or allow a user to initiate a change in the status of a portion of the area being monitored. The security controller 120 is capable of receiving and processing communication messages 140 sent from the wireless security sensor devices 110 using different transmission protocols.

FIG. 2 is a block diagram of the security controller 120 according to one embodiment. The security controller 120 can be similar to the main controller described in U.S. patent application Ser. No. 11/945,607. The security controller 120 includes a transceiver module 210 that is capable of transmitting and receiving security messages and is coupled to a controller module 220. In some embodiments, the security controller 120 may use a receiver module instead of the transceiver module 210 if the security controller 120 is not required to wirelessly transmit data but only wirelessly receive data.

The transceiver module 210 includes a microprocessor component 260 which determines the transmission protocol used in encoding a received security message and passes this information on to a system controller 240 of the controller module 220.

Within controller module 220 is a shared memory portion 230 and a system controller portion 240 implemented with a microprocessor. The shared memory portion 230 consists of an incoming message box 250. The incoming message box 250 is capable of storing a plurality of distinct security messages sent from a wireless security sensor and received by the transceiver 210. In one embodiment, the incoming message box 250 is capable of storing multiple different communication messages received by the transceiver 210.

Both the transceiver module 210 and the system controller portion 240 have access to the shared memory portion 230, with the transceiver module 210 exercising primary control over the shared memory portion 230 and the system controller portion 240 having secondary control. In some embodiments the controller module 220 does not have a shared memory portion 230. In these embodiments, the transceiver module 210 and the system controller 240 are directly connected, for example, via a parallel I/O port or a serial port connection.

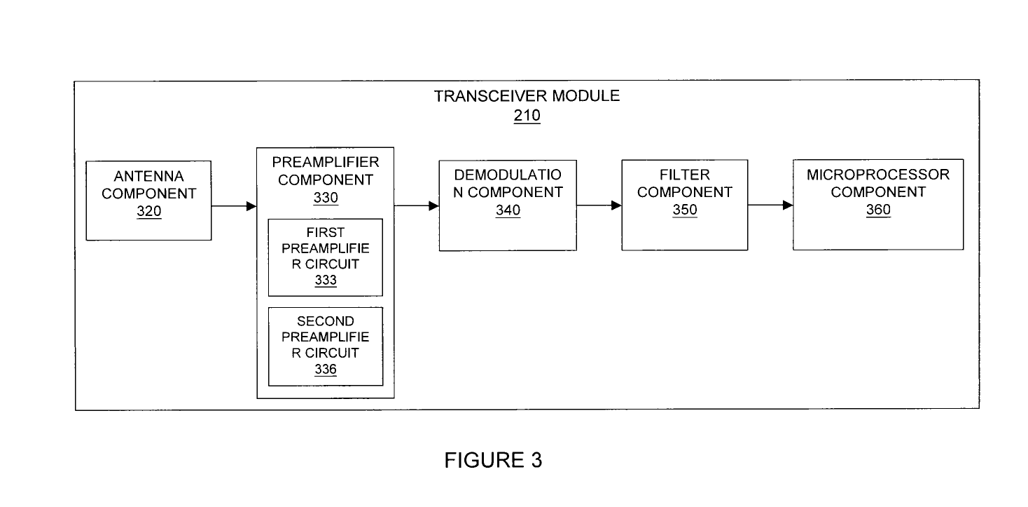

FIG. 3 is a block diagram of one embodiment of the transceiver module 210 for use in the security controller 120 (shown in FIG. 2). The transceiver module 210 is capable of transmitting and receiving security messages and is coupled to a controller module, such as the controller module 220 shown in FIG. 2. In some embodiments, the security controller 120 may use a receiver module instead of the transceiver module 210 if the security controller 120 is not required to wirelessly transmit data but only wirelessly receive data.

The transceiver module 210 includes an antenna component 320, a preamplifier component 330, a demodulation component 340, a filter component 350 and a microprocessor component 360. The antenna component 320 monitors the area for wireless data transmissions over two frequency channels. In one embodiment, the antenna component 320 alternates reception attempts between a first frequency channel and a second frequency channel. The first frequency channel can be set to, for example, 345 MHz and the second frequency channel can be set to, for example, 319.5 MHz. Once a wireless data transmission is received by the antenna component 320, the data transmission is sent to the preamplifier component 330.

The preamplifier component 330 amplifies the received data transmission prior to sending the data transmission to the demodulation component 340. In one embodiment, the preamplifier component 330 toggles between a first preamplifier circuit 333 for amplifying a transmission received over the first frequency channel and a second preamplifier circuit 336 for amplifying a data transmission received over the second frequency channel.

The amplified data transmission is then sent to the demodulation component 340 where the amplified data transmission is demodulated. Once the transmission is demodulated, the transmission is then sent to the filter component 350 to filter away any noise in the data transmission. After the received data transmission is amplified, demodulated and filtered, the transmission is then sent to the microprocessor component 360. The microprocessor component 360 then determines the transmission protocol that was used to encode the data transmission, before sending the data transmission to a controller module, such as the controller module 220 shown in FIG. 2.

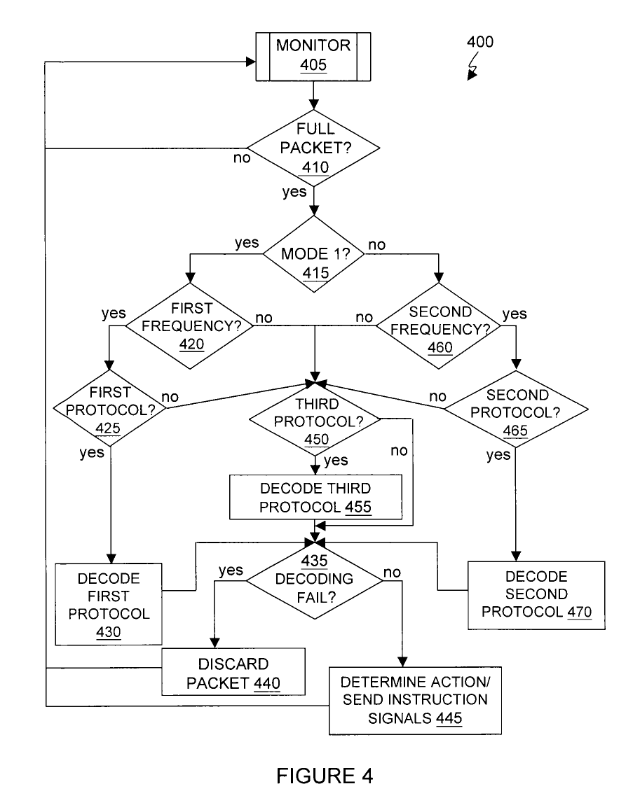

FIG. 4 is a simplified high-level flow chart 400 of a method for a security controller, such as the security controller 120 (shown in FIG. 1), for monitoring and processing security messages sent from security sensors using different transmission protocols. In the embodiment described below, the security controller operates in either a first mode or a second mode. The first mode allows a microprocessor of the security controller to differentiate between security messages that use a system controller's manufacturer transmission protocol (also referred herein as the third transmission protocol) and security messages that use a first transmission protocol of a first manufacturer to allow the security message to be properly decoded. The second mode allows the microprocessor of the security controller to differentiate between security messages that use the third transmission protocol and security messages that use a second transmission protocol of a second manufacturer to allow the security message to be properly decoded. As different manufacturers use different frequency channels for communicating security messages, the first mode is set to receive security messages that use the first transmission protocol over a first frequency channel and the second mode is set to receive security messages that use the second transmission protocol over a second frequency channel. The security controller is able to receive security messages sent from security sensors that use the third transmission protocol over both the first frequency channel and the second frequency channel. Further, for each of the first transmission protocol, the second transmission protocol and the third transmission protocol, a preamble consisting of repeating data bits are used to provide a time during which a data clock can be developed to decode the actual message bits of the security message. The flowchart 400 depicted in FIG. 4 is merely illustrative of one embodiment and other variations, modifications and alternatives could be made by one of ordinary skill in the art.

The flowchart 400 begins at step 405, where a security controller monitors the area and waits until a wireless data transmission is detected. In one embodiment, the security controller alternates reception attempts between the first frequency channel and the second frequency channel. The first frequency channel can be set to, for example, 345 MHz and the second frequency channel can be set to, for example, 319.5 MHz. Once a wireless data transmission is detected the flowchart 400 proceeds to step 410.

At step 410, the security controller dwells on the frequency channel in which the wireless data transmission was detected until a full data packet is received or the reception attempt fails. If a full data packet is received the flowchart 400 proceeds to step 415, otherwise the flowchart proceeds back to step 405.

At step 415, the security controller determines whether it is set to the first mode. If the security controller is set to the first mode, the flowchart 400 proceeds to step 420. If the security controller is not set to the first mode, the security controller is set to the second mode and the flowchart 400 proceeds to step 460.

At step 420, the security controller determines whether the full data packet was received over the first frequency channel. If the full data packet was received over the first frequency channel, the flowchart 400 proceeds to step 425. If the full data packet was not received over the first frequency channel, the security controller concludes that the full data packet was received over the second frequency channel and the flowchart 400 proceeds to step 450.

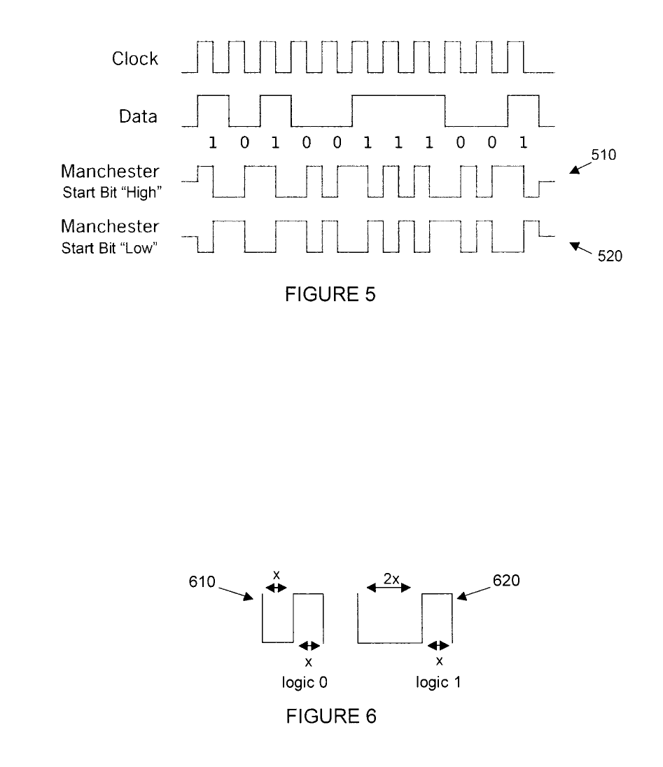

At step 425, the microprocessor of the security controller determines whether the full data packet is encoded using the first transmission protocol. If the full data packet is encoded using the first transmission protocol, the full data packet is ready to be decoded and the flowchart 400 proceeds to step 430. If the full data packet is not encoded using the first transmission protocol, the microprocessor concludes that the full data packet is encoded using security controller manufacturer's transmission protocol and the flowchart 400 proceeds to step 450. For example, in one embodiment, the first transmission protocol uses Manchester encoding with a preamble in which the start bit is set to a low polarity. Accordingly, if the microprocessor determines that the full data packet is using Manchester encoding and the start bit is set to a low polarity, the flowchart 400 proceeds to step 430, otherwise the flowchart 400 proceeds to step 450. As shown in FIG. 5, a digital timing diagram 520 shows a portion of a security message using Manchester encoding using a low polarity start bit. The example of the first transmission protocol is merely illustrative of one embodiment of a transmission protocol and other types of alternative transmission protocols could be used by one of ordinary skill in the art.

At step 430, a system controller of the security controller attempts to decode the full data packet received based on a first transmission protocol and the flowchart 400 proceeds to step 435. As discussed above, in one embodiment the first transmission protocol uses Manchester encoding with a preamble in which the start hit is set to a low polarity.

At step 450, the microprocessor determines whether the full data packet is encoded using the third transmission protocol. If the full data packet is encoded using the third transmission protocol, the full data packet is ready to be decoded and the flowchart 400 proceeds to step 455. If the full data packet is not encoded using the third transmission protocol, the flowchart 300 proceeds to step 435. In one embodiment, for example, the third transmission protocol uses Manchester encoding with a preamble in which the start bit is set to a high polarity. Accordingly, if the microprocessor determines that the full data packet is using Manchester encoding and the start hit is set to a high polarity, the flowchart 400 proceeds to step 455, otherwise the flowchart 400 proceeds to step 435. As shown in FIG. 5, a digital timing diagram 510 shows a portion of a security message using Manchester encoding using a high polarity start bit. The example of the third transmission protocol is merely illustrative of one embodiment of a transmission protocol and other types of alternative transmission protocols could be used by one of ordinary skill in the art.

At step 455, the system controller of the security controller attempts to decode the full data packet received based on the third transmission protocol and the flowchart 400 proceeds to step 435. As discussed above, in one embodiment the third transmission protocol uses Manchester encoding with a preamble in which the start bit is set to a high polarity.

At step 435, the security controller determines whether decoding of the full data packet failed. If the system controller of the security controller failed to decode the full data packet into a security message, the flowchart 400 proceeds to step 440. If the system controller of the security controller is successful in decoding the full data packet into a security message, the flowchart 400 proceeds to step 445. For example, in one embodiment, the security controller determines whether decoding of the full data packet failed by verifying that the checksum of the full data packet matches the transmission protocol used to decode the full data packet. If the checksum fails the flowchart 400 proceeds to step 440, otherwise the flowchart 400 proceeds to step 445.

At step 440, the decoding of the full data packet is determined to have failed and the full data packet is discarded. The flowchart 400 then returns to step 405. At step 445, the system controller of the security controller determines the appropriate action in response to the security message and creates instruction signals based on the appropriate action required. The flowchart 400 then returns to step 405.

As discussed above, when the security controller determines that it is not set to the first mode at step 415, the security controller concludes that it is set to the second mode and the flowchart 400 proceeds to step 460. At step 460, the security controller determines whether the full data packet was received over the second frequency channel. If the full data packet was received over the second frequency channel, the flowchart 400 proceeds to step 465. If the full data packet was not received over the second frequency channel, the security controller concludes that the full data packet was received over the first frequency channel and the flowchart 400 proceeds to step 450, described above.

At step 465, the microprocessor determines whether the full data packet is encoded using the second transmission protocol. If the full data packet is encoded using the second transmission protocol, the full data packet is ready to be decoded and the flowchart 400 proceeds to step 470. If the full data packet is not encoded using the second transmission protocol, the microprocessor concludes that the full data packet is encoded using the third transmission protocol and the flowchart 400 proceeds to step 450, described above. For example, in one embodiment, the second transmission protocol uses a proprietary encoding that uses the ratio of the off time of the carrier to the on time to determine whether a logic “1” or a logic “0” is being transmitted. A logic “0” is determined when the off time and the on time are equal and a logic “1” is determined when the off time is twice as long as the on time. FIG. 6 is a digital timing diagram of portions 610, 620 of a security message using the pulse width based encoding described above. The portion 610 shows a logic “0”, in which the timing of the off signal and the timing of the on signal are both x. The portion 620 shows a logic “1”, in which the timing of the off signal is 2× and the timing of the on signal is x. Accordingly, if the microprocessor determines that the pulse width of the full data packet corresponds to the proprietary encoding of the second transmission protocol, the flowchart 400 proceeds to step 470, otherwise the flowchart 400 proceeds to step 450. The example of the second transmission protocol is merely illustrative of one embodiment of a transmission protocol and other types of alternative transmission protocols could be used by one of ordinary skill in the art.

At step 470, the system controller of the security controller attempts to decode the full data packet received based on the second transmission protocol and the flowchart 400 proceeds to step 435 described above.

FIG. 4 is merely an illustrative embodiment of one method for a security controller to monitor and process security messages sent from security sensors using different transmission protocols. In other embodiments, the security controller can be modified after manufacturing to receive and decode security messages using additional types of transmission protocols and to differentiate between four or more different transmission protocols. Moreover, the embodiment described in FIG. 4 uses the frequency channel that the security message was received, the polarity of the start bit of the security message and the checksum verification to differentiate between different transmission protocols. In other embodiments, the security controller may only require the frequency channel that the security message was received and the polarity of the start bit of the security message or may only require the polarity of the start bit of the security message and the checksum verification to differentiate between different transmission protocols. Also, other factors including: the length of the security message; the data rate of the security message; the preamble length of the security message; the message length of the security message; the message checksum of the security message; the fixed data bits within messages of the security message; the modulation type of the security message (e.g., Amplitude Shift Key “ASK”, Frequency Shift Key “FSK”, On/Off Key “OOK”, etc.); etc., may be used to differentiate between transmission protocols.

The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A system for sending and receiving security messages in a wireless security system, the system comprising:
a multi-protocol security controller capable of receiving the security messages from a security sensor device, the security controller able to differentiate between the two or more transmission protocols to determine the transmission protocol used to encode the security message, decode the security message based on the transmission protocol used to encode the security message, and in response to the decoded security message is capable of generating an instruction signal.

2. The system of claim 1, further comprising one or more security sensor devices, each security sensor device is capable of monitoring a status change in an area and is capable of generating and transmitting a security message encoded using one of two or more different transmission protocols, the security message based on a change in status of the area being monitored.

3. The system of claim 1, wherein the multi-protocol security controller is capable of receiving the security messages sent from the one or more security sensor devices that are transmitted over either a first frequency channel or a second frequency channel or both.

4. A multi-protocol security controller useable in a wireless security system, the multi-protocol security controller comprising:
a receiver module that monitors for a security message; and
a controller module coupled to the receiver module that decodes the security message based on a transmission protocol used to encode the security message, processes the decoded security message and generates an instruction signal based on the decoded security message,
wherein the multi-protocol security controller determines a transmission protocol used to encode the security message between two or more unique transmission protocols.

5. The security controller of claim 4, wherein the receiver module that monitors for a security message over a first frequency channel and over a second frequency channel.

6. The security controller of claim 4, wherein the receiver module is a transceiver that is capable of transmitting the instruction signal.

7. The security controller of claim 4, wherein the receiver module includes a microprocessor that determines the transmission protocol used to encode the security message between the two or more unique transmission protocols.

8. The security controller of claim 4, wherein the controller module determines the transmission protocol used to encode the security message between the two or more unique transmission protocols.

9. The security controller of claim 4, wherein the controller module includes a system controller portion that decodes the security message based on the transmission protocol used to encode the security message, processes the decoded security message and generates an instruction signal based on the decoded security message.

10. A method of receiving security messages using a multi-protocol security controller for a wireless security system, the method comprising:
monitoring an area to be secure over a first frequency channel and second frequency channel using a receiver module of the multi-protocol system controller;
receiving a data transmission over either the first frequency channel and/or the second frequency channel using the receiver module;
determining whether the received data transmission is encoded using one of two or more unique transmission protocols using a microprocessor in the receiver module of the multi-protocol security controller;
decoding a security message from the data transmission based on the transmission protocol used to encode the data transmission using the system controller portion;
generating an instruction signal based on the security message using the system controller portion.
